(19) United States
(12) Patent Application Publication
(10) Pub. No.: US 2009/0024446 A1
(43) Pub. Date: Jan. 22, 2009

(54) Providing a model of a life cycle of an enterprise offering

(76) Inventor: Jerry Z. Shan, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/880,284

(22) Filed: Jul. 20, 2007

(51) Int. Cl. G06F 17/30

(52) U.S. Cl. 705/10

(57) ABSTRACT

According to information regarding an enterprise offering, characteristics of a life cycle of the enterprise offering are determined. A model including functions representing segments of the life cycle is produced based on the determined characteristics.

### BACKGROUND

A product offered by a business usually has a life cycle that is associated with several phases, such as a ramp-up phase, a maturity phase, and a ramp-down phase. The ramp-up phase represents demand for the product during some initial time period after introduction of the product. The maturity phase represents demand for the product after the product has been in the marketplace for some amount of time. The ramp-down phase represents demand for the product in the time period near the end-of-life of the product.

Some businesses attempt to provide forecasts of demand for new products based on life cycles of previous products. However, the analyses of life cycles of products that are typically performed are analyses that can be time-consuming, labor-intensive, and inaccurate.

### BRIEF DESCRIPTION OF THE DRAWINGS

Some embodiments of the invention are described with respect to the following figures:

FIGS. 1-3 are graphs that illustrate example life cycles of an enterprise offering that can be modeled according to some embodiments;

FIG. 4 is a flow diagram of a process of identifying breakout points in a life cycle analysis according to an embodiment;

FIGS. 5A-5B are graphs illustrating normalization of life cycles for multiple enterprise offerings, according to an embodiment;

FIG. 6 is a flow diagram of a process of normalizing life cycles of enterprise offerings, according to an embodiment; and

FIG. 7 is a block diagram of an arrangement including a computer that includes life cycle analysis software according to some embodiments.

### DETAILED DESCRIPTION

A technique according to some embodiments allows for an automated and systematic analysis of a life cycle of a particular enterprise offering. An “enterprise offering” refers to either a product or a service offered by enterprise (e.g., a business, educational organization, or government agency). The technique of analyzing the life cycle of an enterprise offering is performed by an automated analysis tool which allows for the development of accurate models for life cycles of various enterprise offerings. The accurate models allow for proper analysis based on life cycles of enterprise offerings, where the analysis can include forecasts of demand for new enterprise offerings, such as new products or services.

The life cycle of an enterprise offering is typically associated with several phases. The automated analysis tool according to some embodiments is able to automatically identify the phases of the life cycle of an enterprise offering. In some embodiments, the technique used is a linear regression technique in which segments corresponding to the phases of the life cycle of an enterprise offering are determined based on performing linear regression to identify different linear segments corresponding to the various phases of the enterprise offering. Example phases of the life cycle of an enterprise offering include a ramp-up phase (a phase after initial introduction of the enterprise offering), a maturity phase (a phase after an enterprise offering has been introduced for some amount of time), and a ramp-down phase (a phase corresponding to the time period close to the end-of-life of the enterprise offering). Other example phases associated with the life cycle of a product include a stock-in phase and a clean-out phase. The stock-in phase is the phase after the ramp-up phase resulting from an initial peak in demand for a product resulting from supply of inventories of product stock to resellers, wholesalers, or other entities. The clean-out phase refers to the phase after ramp-down, during which product stock of resellers, wholesalers, or other entities is being depleted.

In the ensuing discussion, reference is made to life cycles of products. Note, however, that techniques according to some embodiments can also be applied to analysis of life cycles of other enterprise offerings, including services.

Historical time series can be provided for one or more products, where each time series contains data values over time for each corresponding product. The data values can represent demand, such as total number of units sold, revenue, and so forth. Basically, a time series for a particular product represents a life cycle of the product.

In accordance with some embodiments, the analysis tool is able to model each phase of the life cycle of a product with a linear function from the beginning of the phase to the end of the phase. The benefits of using linear functions to represent the corresponding phases of the life cycle is that the life cycle of the product can be modeled simply with piecewise functions, where each linear function can be parameterized with just two parameters: the slope term and an intercept term. The slope term refers to the slope of the linear function, and the intercept term refers to a point intercepted by the line represented by the linear function. Each linear function of the life cycle represents a corresponding segment (or phase) of the life cycle. A segment of the life cycle can exhibit a local trend, such as increasing trend (e.g., during ramp-up or during maturity) or a decreasing trend (e.g., such as during ramp-down).

After segmenting a time series into respective segments that are associated with corresponding phases of the life cycle, a linear regression technique can be applied to identify linear segments (represented by corresponding linear functions). The multiple linear functions representing different time series segments form an overall linear regression model for the time series. The overall linear regression model allows for quantification of the life cycle so that analysis (e.g., forecasting) can be performed based on the life cycle of the product.

Identification of the segments of the life cycle is based on determined characteristics of the life cycle. In some embodiments, the determined characteristics include boundary points (also referred to as “breakout points”) that define the segments. Examples of other characteristics include any information relating to the life cycle of an enterprise offering from which segments representing phases of the life cycle can be determined.

Although reference has been made to a linear regression technique to identify linear functions to represent segments of the life cycle of an enterprise offering, it is noted that other embodiments can use other techniques to develop other (non-linear) functions for representing segments of the life cycle of an enterprise offering.

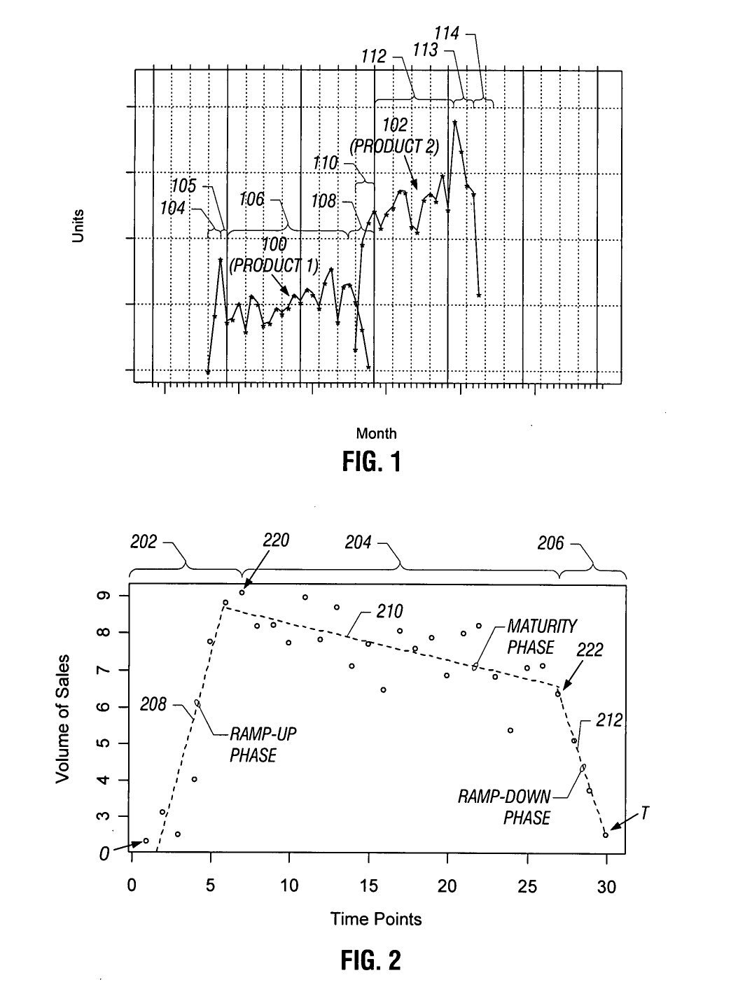

FIG. 1 illustrates two curves 100 and 102 that represent time series for two different products. The time series contain data values representing demand (in terms of units sold) for the two products. As depicted in FIG. 1, each of the time series is associated with four segments that correspond to four different phases of the life cycle of each product. For the time series represented by curve 100, the segments include a first segment 104 that represents the ramp-up phase of the life cycle of the first product, a segment 105 that represents a stock-in phase (phase starting from a peak in demand due to initial inventory stocking to resellers, wholesalers, or other entities, and ending at a time point that is the beginning of the maturity phase), a segment 106 that represents the maturity phase of the life cycle of the first product, and a segment 108 that represents the ramp-down phase of the life cycle of the first product. The curve 102 representing the time series for the second product includes a first segment 110 that represents the ramp-up phase of the life cycle for the second product, a segment 112 that represents the maturity phase of the life cycle of the second product, a segment 113 representing the clean-out phase of the life cycle for the second product, and a segment 114 that represents the ramp-down phase of the life cycle of the second product. Note that for the first product, there is no clean-out phase, and for the second product, there is no stock-in phase.

In performing the linear regression technique to identify segments according to some embodiments, a challenge is to identify breakout points that define the various segments. “Breakout points” or “boundary points” refer to points in a graph that define boundaries of the segments of the life cycle of a product. Note that the number of breakout points is unknown before the end of the life cycle for a product has been reached, as the number of phases associated with the life cycle of a particular product may be unknown. For example, in some cases, a stock-in phase may not be present, while in other examples, a clean-out phase may not be present.

Also, if a model of a life cycle of a particular product (e.g., new product) is to be based on multiple time series for multiple other products (e.g., past products), then normalization may have to be performed on time series to account for differences in time durations of the various phases of the life cycles for the multiple products. The normalized time series are then used to develop the model of the life cycle of the particular product.

In the simplest case, it can be assumed that there are two breakout points (such that there are three phases and thus three segments to be identified for a time series). An example of a time series with two breakout points is depicted in FIG. 2. Various data points (represented as circles) are plotted in the graph of FIG. 2 to represent sales volume as a function of time points for a particular product. Three phases are present in the time series of FIG. 2: a ramp-up phase 202, a maturity phase 204, and a ramp-down phase 206. In the example of FIG. 2, the ramp-up phase starts at time point 1 (corresponding to initial point O) and ends at time point 7, the maturity phase starts at time point 7 and ends at time point 27, and the ramp-down phase 206 starts at time point 27 and ends at time point 30 (corresponding to terminating point 7). In the example of FIG. 2, the two actual breakout points are located at time points 7 and 27, with the sales volume values of these two time points being 9 and 6, respectively, in the example. Generally, a breakout point is defined to be a time point at which one phase in the life cycle ends and a subsequent phase starts.

Since the analysis tool is unaware ahead of time where the actual breakout points are located, the analysis tool has to initially guess where these breakout points are. In some cases, small ranges can be specified for the breakout points from which the analysis tool can select estimated breakout points. However, in some cases, since stock-in and clean-out are planned activities, there is some advanced knowledge of the presence of certain breakout points.

In the example of FIG. 2, the estimated breakout points are selected to be at time points 6 and 27. Based on these estimated breakout points, linear functions can be developed for the three different phases to produce line segments 208 between time point 1 and time point 6 to represent the ramp-up phase 202, a second line segment 210 between time point 6 and time point 27 to represent the maturity phase 204, and a third line segment 212 between time point 27 and time point 30 to represent the ramp-down phase 206. Note that estimated time point 6 is an incorrect guess since the actual breakout point is at time point 7 in the example of FIG. 2.

Next, a residual sum of squares (RSS) analysis is performed, in which the difference between the actual data values (observed data values in the time series) and projected data values (based on the line segments 208, 210, and 212) is determined. The difference is the residual, which is squared and summed over the time points of the time series. Formally, the residual sum of squares (RSS) is represented as follows:

$$RSS = {\sum }_{t = 1}^{N} {( {x}_{t} - f ( {x}_{t} ) )}^{2} , \qquad ( Eq . 1 )$$

where x₁ represents observed data values of the time series, and f(x₁) represents projected data values based on the line segments produced according to the estimated breakout points, and t represents the time points of the time series.

After the initial guess, another set of guesses for the breakout points can be made. In one example, the second guess for breakout points can be time points 7 and 27, which correspond to the actual breakout points. The RSS calculated for the second set of estimated breakout points would be less than the RSS for the first set of estimated breakout points. The RSS is an objective function to be minimized to identify the best estimated breakout points. In the above example, minimizing RSS would result in selection of the second set of estimated breakout points.

In other embodiments, instead of using RSS as the objective function, another objective function such as the sum of the absolute deviation can be used to identify the best breakout points for purposes of life cycle model analysis.

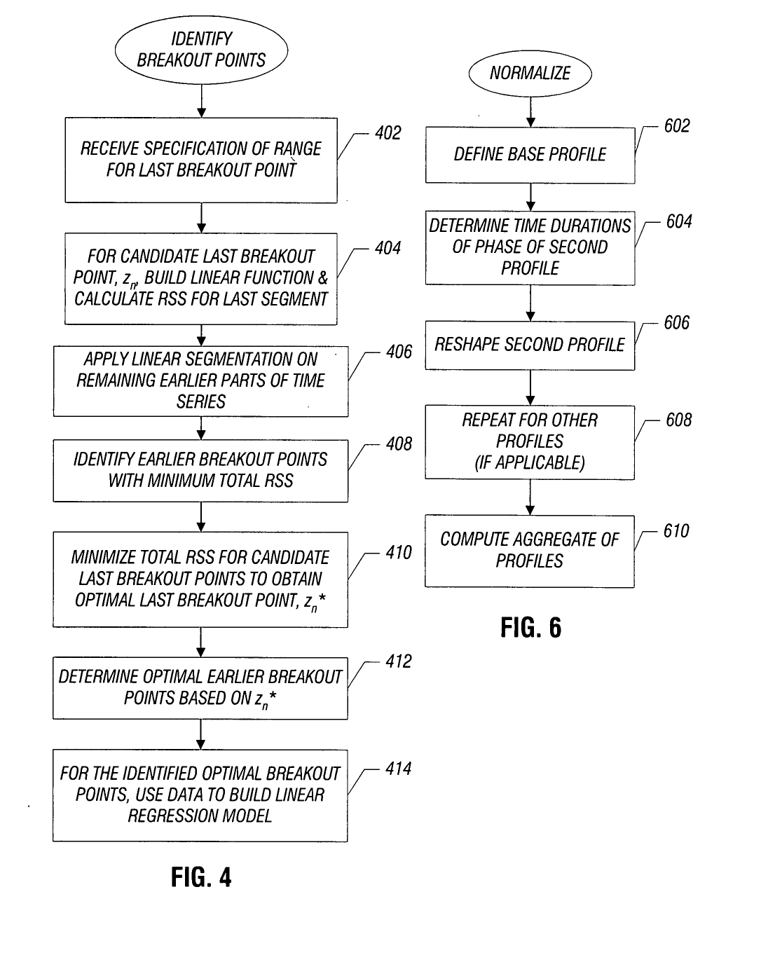

In a process according to some embodiments, identification of the breakout points starts with the last breakout point and moves backwardly to find earlier breakout point(s). For example, in FIG. 2, the process first starts by identifying the breakout point 222 to achieve minimum RSS, and then using this identified last breakout point 222, works backwardly to find breakout point 220 with the minimum RSS. A more detailed discussion of the process is described in connection with FIG. 4 below.

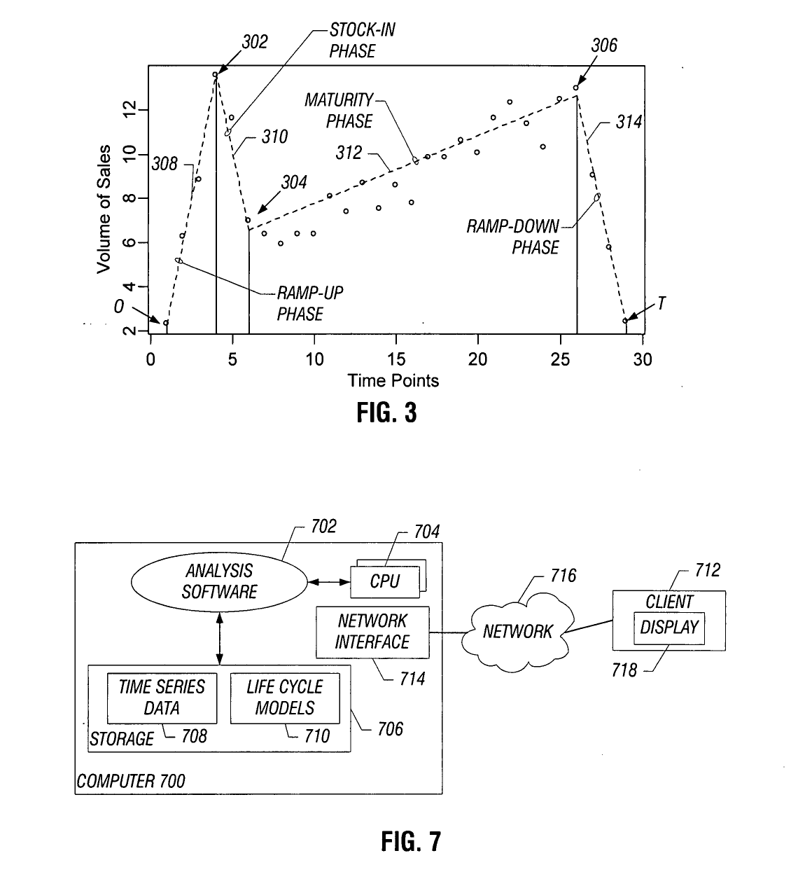

FIG. 3 shows an alternative example time series with three breakout points, where the time series depicted in FIG. 3 is associated with a breakout point 302 that represents the stock-in peak. The other breakout points in the example of FIG. 3 include breakout points 304 and 306. As a result, four segments are present: a first segment 308 that represents the ramp-up phase from the initial point O to the stock-in peak (302); a second segment 310 that represents a dip in the demand (stock-in phase) from the stock-in peak to the breakout point 304; a third segment 312 that represents the maturity phase between breakout points 304 and 306; and a fourth segment 314 that represents the ramp-down phase between the breakout point 306 and the terminating point T. A similar process as discussed above can be used to identify the breakout points of FIG. 3.

FIG. 4 shows a flow diagram of identifying breakout points in accordance with an embodiment. The process can be performed by an analysis tool. The analysis tool receives (at 402) specification of a range for a last breakout point in the life cycle. The specification of the range can be received from users who are knowledgeable about a particular type or class of product. For example, the user can be a product manager who is knowledgeable about marketing information or the marketing plan for a particular product.

Next, for a candidate last breakout point, zₙ, which is selected from the specified range, a linear function is built (at 404) to define the linear segment between the last breakout point, zₙ, and the terminating point (T) (e.g., last segment 212 in FIG. 2 or last segment 314 in FIG. 3). Note that the value of n can be two or greater. The linear segment is represented as zₙ-T. The RSS is also calculated for this last segment.

Next, the analysis tool applies (at 406) linear regression segmentation on the earlier parts of the time series by considering various candidates for the various earlier breakout points, zₙ₋₁, . . . , z₁, where z₁ is the first (earliest) breakout point in the time series.

The linear regression segmentation performed at 406 also involves the calculation of various RSS values for the various breakout points considered. The total RSS calculated is based on the following segments: O-z₁, z₁-z₂, . . . , zₙ₋₁-zₙ, where O stands for the initial point.

The total RSS calculated above as well as the RSS for the last segment are both functions of zₙ. Given the identified earlier breakout points (performed at 408) with minimum total RSS, various other values of zₙ are considered, and the total RSS is calculated for these other values of zₙ. The minimum RSS value is obtained to find (at 410) the optimal last breakout point, represented as z*ₙ.

Given the optimal last breakout point, z*ₙ earlier optimal breakout points, represented as z*ₙ₋₁, . . . , z*₁, are identified (at 412) by considering other possible earlier breakout points and computing corresponding total RSS values for these other possible earlier breakout points. The identified earlier optimal breakout points correspond to the minimum total RSS value.

Based on the foregoing, an optimal set of breakout points, z*ₙ, z*ₙ₋₁, . . . , z*₁, is identified. Once the optimal breakout points have been identified, the data in the various phases defined by the breakout points is used to build (at 414) a piece-wise linear regression model that specifies the slopes, intercept time points, and run-rates for the various phases of the time series. The run-rate of the time series is associated with the maturity phase of the life cycle of the time series, where the run-rate refers to the stable demand rate during the maturity phase. The piece-wise linear regression model represents the life cycle model for a particular product.

Generally, the process according to FIG. 4 first identifies characteristics of the life cycle of the enterprise offering being considered, where the identified characteristics include boundary points in some embodiments. Once such characteristics have been identified, functions representing segments of the life cycle are derived, where the functions collectively form a model of the life cycle. Based on such model, some analysis can be performed, such as forecasting of demand for a new enterprise offering.

The process of FIG. 4 can be repeated for other products. In some cases, the process of FIG. 4 can be repeated for multiple products such that multiple life cycle models are created. In some scenarios, it may be desirable to produce a life cycle model for a future product based on an aggregate of the multiple life cycle models for multiple corresponding products. An issue associated with aggregating (e.g., taking a mean or median of) multiple life cycle models is that the durations of phases within the life cycles for the multiple products may be different.

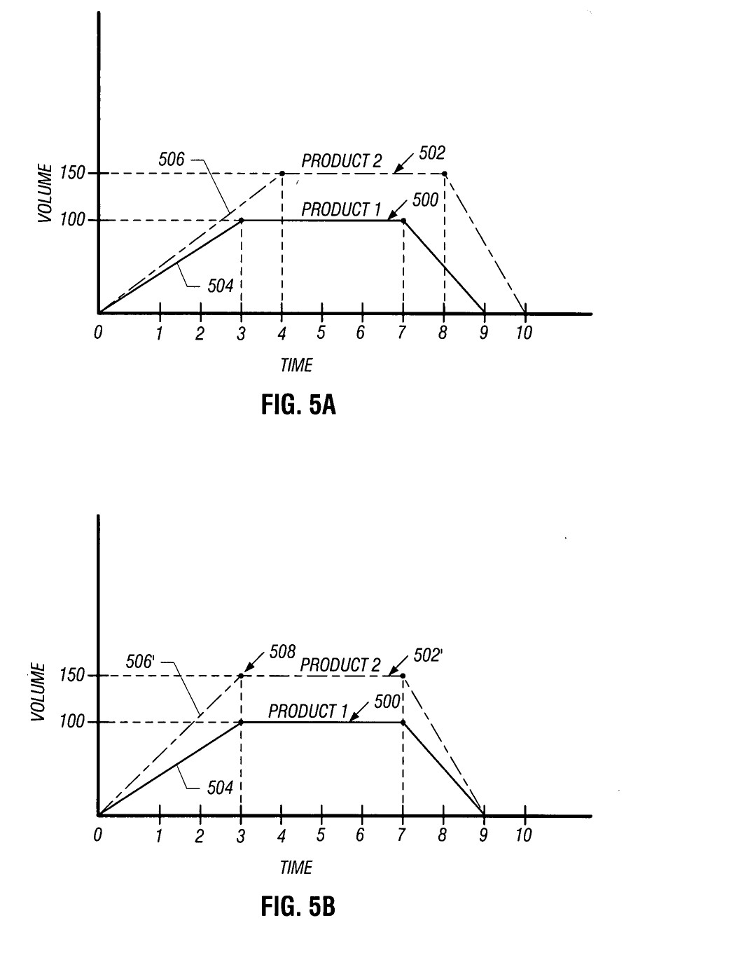

As depicted in the example of FIG. 5A, two profiles 500 and 502 are depicted, where profile 500 represents the life cycle model of a first product, and profile 502 represents the life cycle model of a second product. Note that each of the two life cycles represented by the two profiles 500 and 502 include three phases (defined by two breakout points). However, the first phase 504 of the first life cycle (500) is shorter (in time duration) than the first phase 506 of the second life cycle (502). The duration of the first phase 504 is three time points, whereas the duration of the first phase 506 is four time points. Also, the total duration of the first life cycle model is 9 time points, whereas the total duration of the second life cycle model is 10 time points. Due to the different time durations of phases and different overall time durations between the two profiles 500 and 502, taking an aggregate (e.g., mean or median) of the two profile 500 and 502 to provide the life cycle model of a future product would not provide an accurate result. In accordance with some embodiments, before an aggregate can be taken of the two different life cycle models, normalization is first performed.

FIG. 6 is a flow diagram of a normalization procedure performed by the analysis tool according to some embodiments. For multiple profiles representing life cycle models of respective multiple products, one of the profiles is defined (at 602) as the base profile. The other profile(s) are to be normalized according to this base profile.

The time durations of the various phases of a second profile (that is to be normalized with respect to the base profile) are determined (at 604). Next, based on a comparison of the time durations of the phases of the second profile to the base profile, the second profile is reshaped (at 606) such that the time durations of the phases of the second profile are equal to the time durations of the phases of the base profile. In one example, as depicted in FIG. 5B, the first phase 506 (FIG. 5A) of the second profile 502 is re-shaped to a first phase 506′ (FIG. 5B) of a reshaped second profile 502′. As a result of the reshaping, the slope of the first phase 506′ has been changed from the original first phase 506 (as has the intercept point 508 of the reshaped first phase 506′, which is now at time point 3 rather than time point 4 as depicted in FIG. 5A). Although the intercept time point of the first phase 506′ has been shifted backwardly, the value in the vertical axis (volume value) stays the same. Note that the second and third segments of the profile 502′ have been shifted back in time by one time point; however, the run-rate and slope of these segments have not changed.

If other profiles have to be processed, such other profiles are also reshaped with respect to the base profile (at 608). Next, an aggregate of the various profiles, including the base profile and reshaped other profile(s) is computed (at 610), where the aggregate can be a mean or a median (or some other type of aggregate). The aggregated profile represents the aggregate life cycle model for the target product, which can be a future product.

Using the aggregate life cycle model, forecasting or other analysis can be performed, such as to perform a forecast of sales of a soon-to-be-released product.

The analysis tool referred to above for performing various tasks can be implemented as an analysis software 702 (as depicted in FIG. 7). The analysis software 702 is executable on one or more central processing units (CPUs) 704 in a computer 700. The computer 700 also includes a storage 706 to store various data, including time series data 708 (e.g., multiple time series for multiple enterprise offerings). Also, various life cycle models 710 can be stored in the storage 706, where the life cycle models 710 are generated by the analysis software 702 based on the time series data 708.

The life cycle models 710, or reports or other outputs based on the life cycle models 710, can be communicated to a client computer 712 through a network interface 714 of the computer 700 and over a data network 716. The life cycle models 710, or reports or other outputs based on the life cycle models, can be presented to a user through a display 718 of the client computer 712. Alternatively, a display can be directly attached to the computer 700 to provide output information regarding the life cycle models 710.

Instructions of software described above (including the analysis software 702) are loaded for execution on a processor (such as one or more CPUs 704). The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method executed by a computer, comprising:
according to information regarding an enterprise offering, determining characteristics of a life cycle of the enterprise offering; and
producing a model that includes functions representing segments of the life cycle according to the determined characteristics.

2. The method of claim 1, wherein determining the characteristics of the life cycle of the enterprise offering comprises determining boundary points that define various phases of the life cycle of the enterprise offering, wherein the segments correspond to the phases.

3. The method of claim 1, wherein producing the model comprises producing the model using a linear regression technique.

4. The method of claim 3, wherein the determined characteristics include boundary points, and wherein using the linear regression technique comprises defining linear segments based on the boundary points.

5. The method of claim 1, further comprising:
defining an objective function; and
identifying boundary points defining the segments of the life cycle of the enterprise offering based on the objective function.

6. The method of claim 5, wherein defining the objective function comprises defining a residual sum of squares or a residual sum of absolute values objective function.

7. The method of claim 1, wherein the segments of the life cycle of the enterprise offering are defined by boundary points, the method further comprising:
identifying the boundary points by first identifying a last one of the boundary points and working backwardly to identify earlier one or more of the boundary points.

8. The method of claim 7, wherein identifying the boundary points comprises identifying optimal boundary points based on minimizing an objective function.

9. The method of claim 1, wherein producing the model comprises producing a linear regression model of the life cycle of the enterprise offering.

10. The method of claim 1, further comprising:
according to information regarding a second enterprise offering, determining characteristics of a second life cycle of the second enterprise offering; and
producing a second model that includes functions representing segments of the second life cycle based on the determined characteristics of the second life cycle.

11. The method of claim 10, further comprising:
aggregating the models of the enterprise offerings to provide an aggregate model to enable analysis with respect to a third enterprise offering.

12. The method of claim 11, further comprising:
defining one of the models as a base model;
normalizing another of the models based on the base model,
wherein aggregating the models comprises aggregating the base model with the normalized model.

13. The method of claim 11, further comprising using the aggregate model to perform forecasting for the third enterprise offering.

14. The method of claim 1, wherein determining the characteristics of the life cycle of the enterprise offering comprises determining the characteristics of the life cycle of one of a product and a service provided by an enterprise.

15. The method of claim 1, wherein determining the characteristics of the life cycle of the enterprise offering comprises determining that the life cycle has plural phases including at least a ramp-up phase, a maturity phase, and a ramp-down phase.

16. A method executed by a computer, comprising:
building models representing life cycles of plural corresponding enterprise offerings;
normalizing at least one of the life cycle models based on another of the life cycle models; and
aggregating the life cycle models including the normalized at least one life cycle model to produce an aggregate life cycle model.

17. The method of claim 16, further comprising performing analysis using the aggregate life cycle model for a further enterprise offering.

18. The method of claim 17, wherein performing the analysis comprises performing forecasting of demand for the further enterprise offering.

19. Instructions on a computer-usable storage medium that when executed cause a computer to:
according to information regarding an enterprise offering, determine boundary points relating to segments of a life cycle of the enterprise offering; and
produce, using a linear regression technique, a model of the segments of the life cycle based on the determined boundary points.

20. The instructions of claim 19, wherein determining the boundary points comprises:
defining an objective function;
selecting various estimates of the boundary points; and
identifying the determined boundary points using the objective function.
